(19) United States
(12) Patent Application Publication
(10) Pub. No.: US 2012/0035033 A1
(43) Pub. Date: Feb. 9, 2012

(54) DEVICE FOR SUPPLYING SHEETS

(75) Inventor: Fiorenzo Draghetti, Medicina (BO) (IT)

(73) Assignee: GIMA S.P.A., Zola Predosa (BO) (IT)

(21) Appl. No.: 13/264,443

(22) PCT Filed: Apr. 13, 2010
(86) PCT No.: PCT/IT2010/000159

§ 371 Date: Oct. 14, 2011

(30) Foreign Application Priority Data
Apr. 17, 2009 (IT) TO2009A000300

(51) Int. Cl. B31B 3/00; B65G 47/52; B65G 47/02; B65G 17/12; B65G 37/00

(52) U.S. Cl. 493/162; 198/803.3; 198/463.1

(57) ABSTRACT

A device (1) is described herein for supplying rough-shaped sheets, made especially of cardboard, for making a corresponding package for housing respective cigarettes or the like. The device comprises means (11) for supporting and conveying sheets (A) along a respective path, which comprise first and second means (111, 112) that still-retain respective ends (A1, A2) of the sheet (A) along the advancement path.

The present invention refers to a device for supplying sheets.

Said sheets are, in particular, in the form of rough-shaped sheets, especially made of bendable material, preferably cardboard, for making a corresponding container, or part of a container. Said container is, in particular, in the form of a package for housing respective elongated articles such as cigarettes or the like.

Devices for supplying sheets are known, especially rough-shaped cardboard sheets for making corresponding packages for cigarettes.

Essentially, these devices known for supplying rough-shaped sheets comprise respective means for supporting and conveying rough-shaped sheets along a respective path.

In particular, according to a known typology of devices, means for supporting and conveying said rough-shaped sheets have respective guides, engaging also the central part of the sheet, and pushers for engaging and advancing said sheets, that contact said rough-shaped sheets at a central area of the same sheets. In these known devices, the shape and size of the guides and, in particular, of the pushers, therefore, depends essentially on the conformation of the rough-shaped sheet to be provided and varies, therefore, from one type of sheet to another, i.e. one package type to another.

Other devices are also known for supplying rough-shaped sheets that present means for supporting and advancing sheets, which are defined by suction and retention planes of the respective rough-shaped sheet, which comprise a plurality of suction holes positioned so as to engage, substantially, the entire surface of the rough-shaped sheet, with said holes that are then, essentially provided in areas where a corresponding portion of the rough-shaped sheet essentially extends. Also the configuration of these devices for supplying the rough-shaped sheets of a known type, in particular the width of the suction surface and the arrangement of the holes thereof, is, therefore dependent on the shape and size that said sheet presents, varying from one type of sheet to another or one type of package to another.

Practically, the devices hereto known result to be inflexible in use, requiring, in order to feed rough-shaped sheets having different conformations, to perform complex operations of parts replacement, such as guides and pushers, or the engaging and supporting surface of the rough-shaped sheet, in the case of suction suppliers.

Practically, according to devices of the known art, in case of size change, major structural changes must be made, that are annoying operations executed by employees which require prolonged stop-time of the machinery.

A device for supplying sheets is provided, particularly rough-shaped sheets, especially made of bendable material, preferably cardboard, for making a corresponding container, or part of a container; said container preferably defining a package for housing respective elongated elements, particularly consisting of cigarettes or the like; the device comprises means for supporting and conveying sheets along a respective path; and is characterized by the fact that said supporting and conveying means comprise first and second means for retaining the respective ends of the sheet.

In this way, it is possible to make the configuration of the supporting and conveying means substantially independent, or easily adaptable, with respect to the different types and sizes of sheets to be fed.

Corresponding relative advantages are therefore achieved in convenience and execution time of size change for the machines to which this device is associated.

The technical characteristics of the finding, according to the aims mentioned, are clearly evident from the content of the claims below, and the mentioned advantages thereof will become more evident in the detailed description that follows, made with reference to the attached drawings, which represent an embodiment purely exemplificative and not limiting, in which:

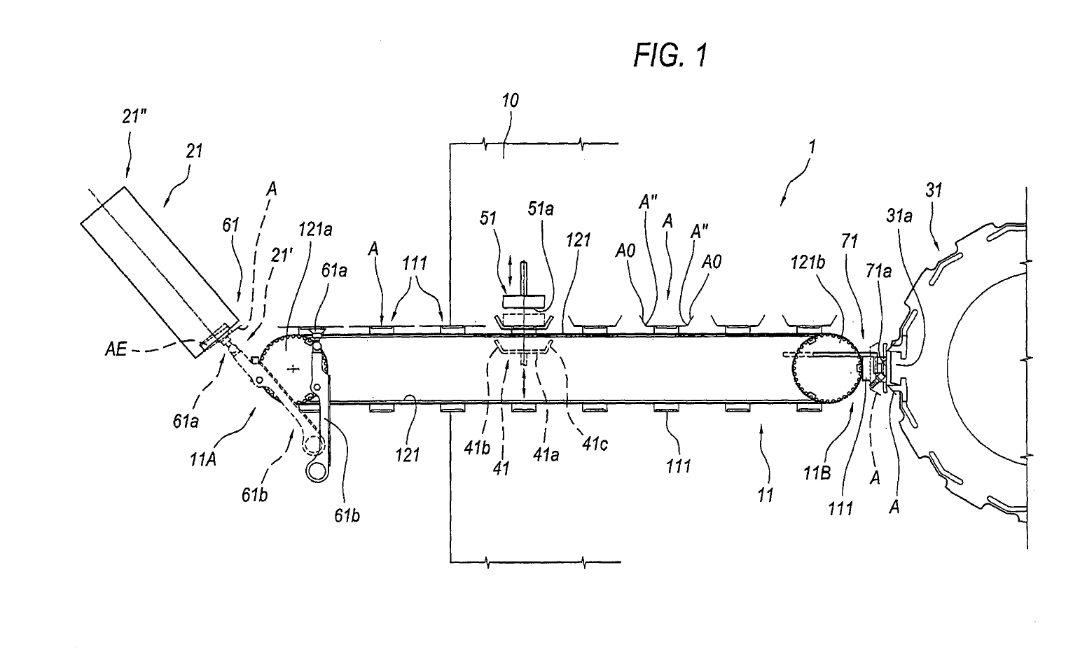

FIG. 1 shows a longitudinal sectional view of a preferred embodiment of the device according to the present invention;

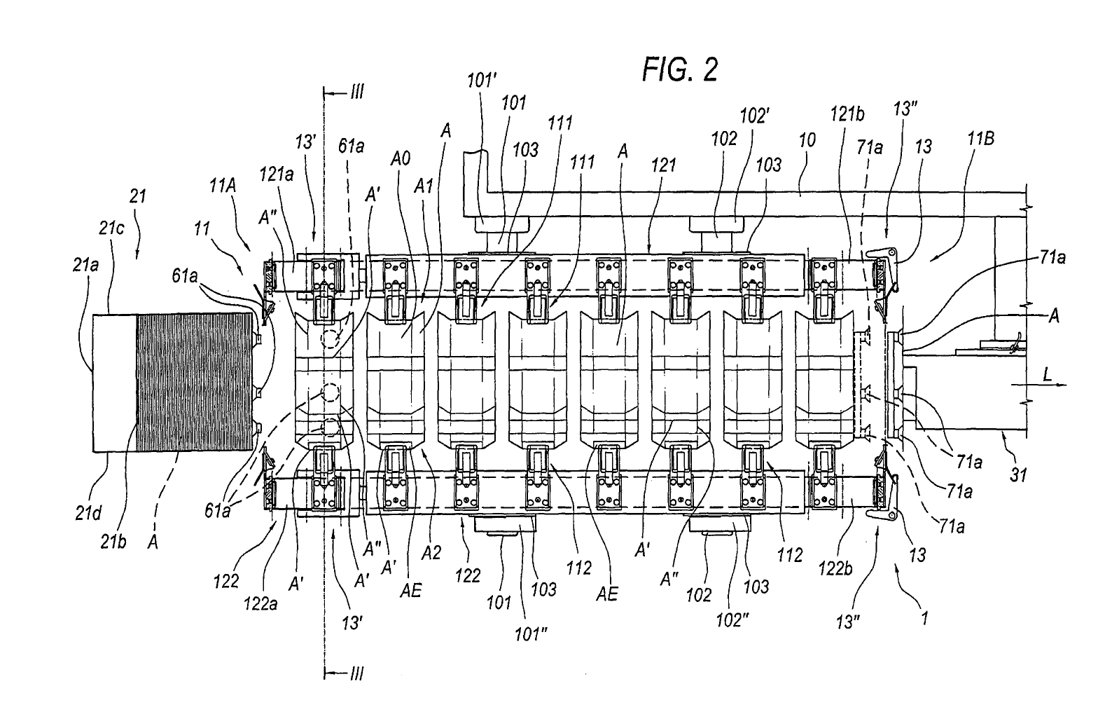

FIG. 2 shows a schematic top view of the preferred embodiment of the device according to the present invention;

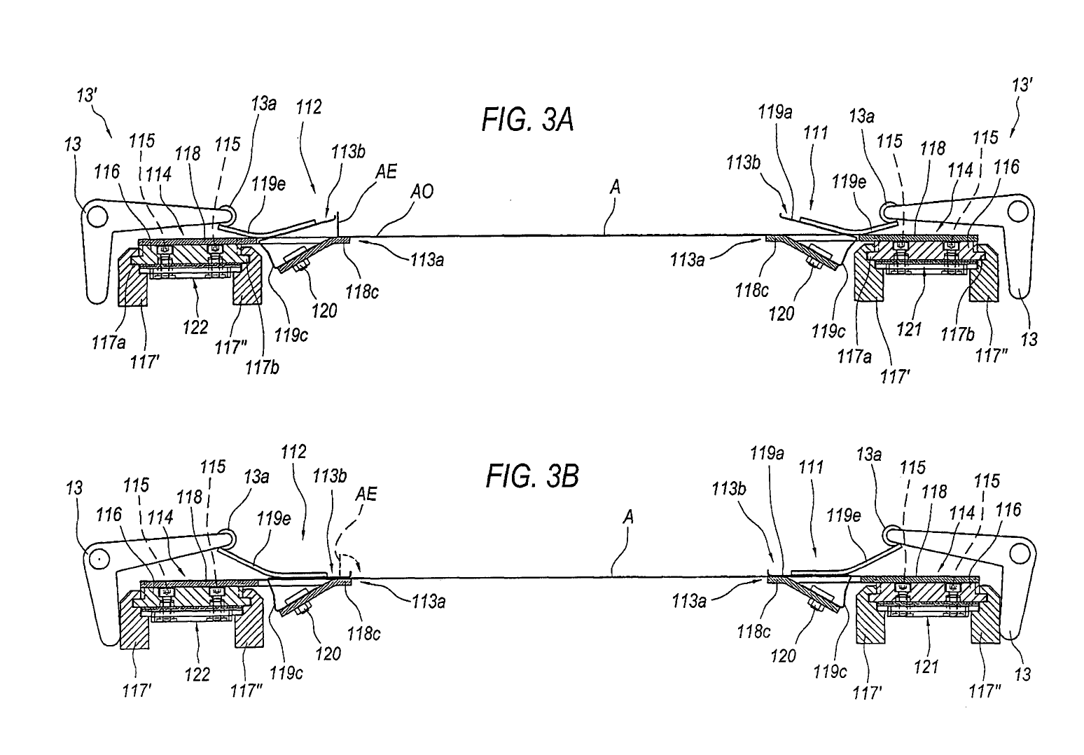

FIGS. 3A and 3B show respective cross sectional schematic views, taken along line of FIG. 2, illustrating different positions of said grasping pliers of the rough-shaped sheet of the present preferred embodiment according to the present finding;

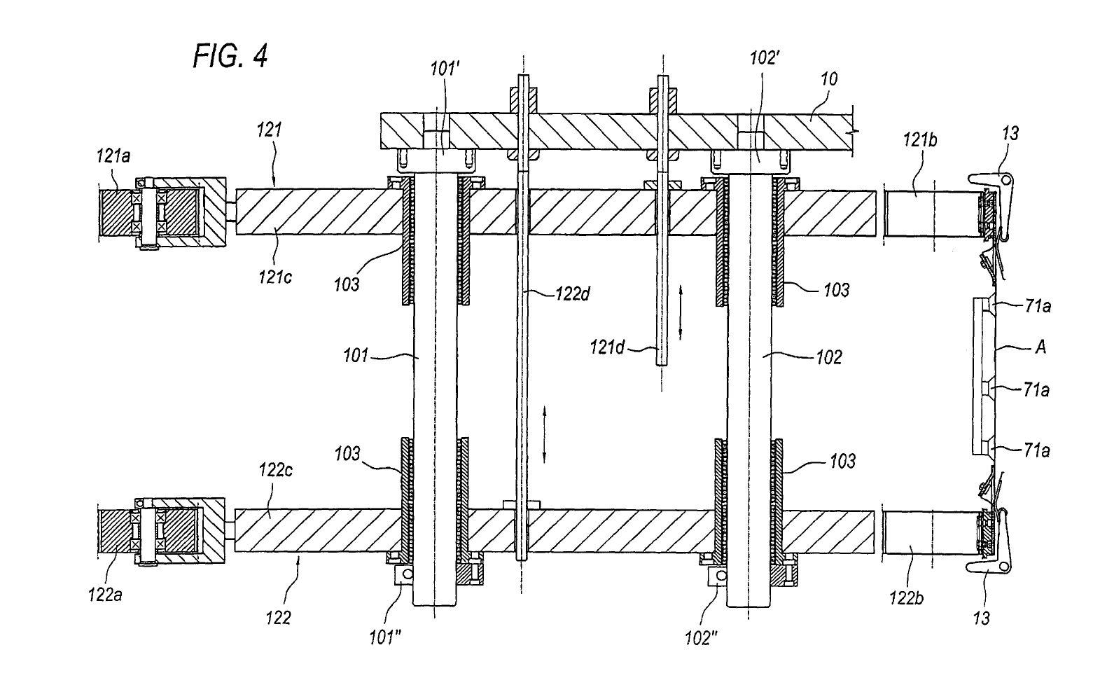

FIG. 4 shows a horizontal sectional view of the underside of this device, showing in particular the means to provide adjustment of the cross width of the retaining and conveying means;

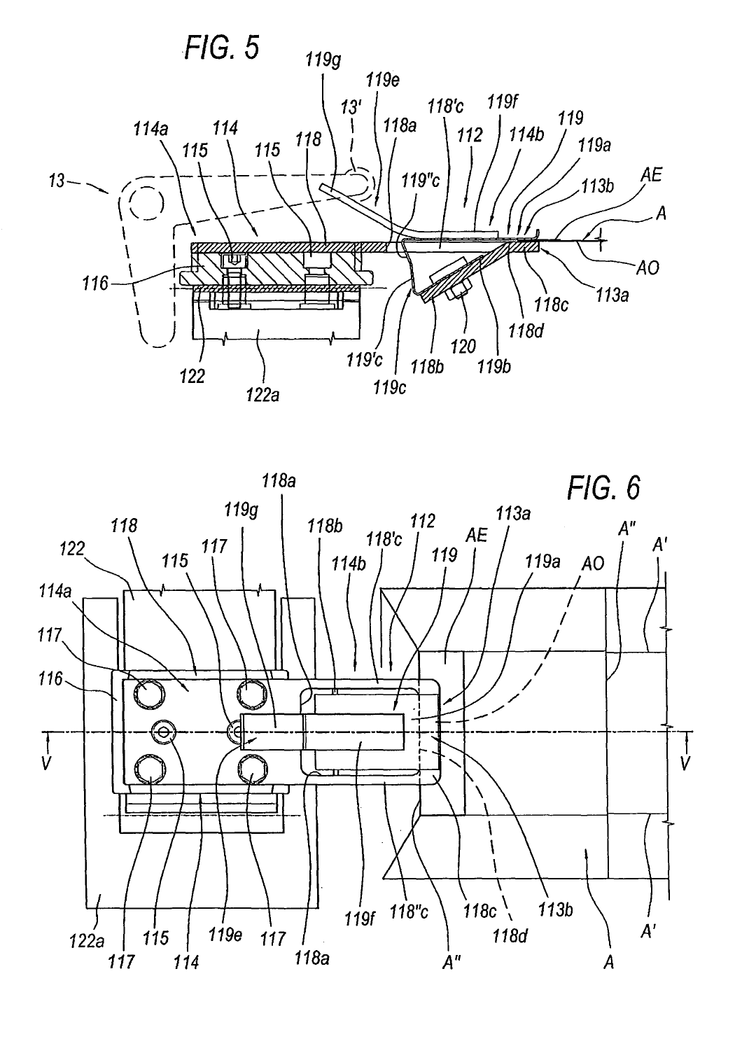

FIG. 5 shows a cross sectional view, taken along line V-V of FIG. 6, showing a detail relative to the grasping pliers of a sheet end;

FIG. 6 shows a top plan view showing a detail relative to the grasping pliers of a sheet end.

In the attached figures, a preferred embodiment is shown of a device 1 for supplying sheets A, which are especially constituted of rough-shaped sheets, especially made of bendable material, preferably cardboard, for making a corresponding container, or part of a container.

The container is adapted to make a corresponding package, or package part, to house the respective elongated elements or articles, particularly consisting in cigarettes, or similar, preferably packaged in a respective wrapping or film.

Sheet A extends, preferably, with a prevalent development direction, which in the present device extends transversely to the advancement or longitudinal direction, and presenting respective ends A1, A2, or transverse ends of the sheet, with reference to the longitudinal or advancement direction of the same sheet; marked by the arrow “L” in FIG. 2.

Sheet A presents respective panels A0, bendable along pre-defined lines in sheet A, which mainly, but not exclusively, extend parallel, A′, and transverse, A″, to the advancement direction of said sheets, or a longitudinal direction.

The present device 1 comprises means 11 for supporting and conveying sheets along a respective path, between an upstream receiving end 11A of sheets, preferably, as shown by a respective magazine 21, and a downstream unloading or transfer end 11B of said sheets, preferably a corresponding package-forming wheel 31.

Advantageously, supporting and conveying means 11 comprise first and second means 111, 112 that are adapted to retain respective ends A1, A2 of sheet A, said retaining means being movable, or advanced, along a corresponding conveying path of said sheets.

In particular, the means 111, 112 are adapted to firmly retain respective ends A1, A2 of the sheet A, defining the means for supporting the sheets and being supported and advanced by respective conveying means 121, 122.

Practically, the respective sheet is retained in suspension, between the first and second retaining means 111, 112, i.e. the respective sheet is maintained uplifted solely by said first and second retaining means 111, 112.

The paths of said first and second retaining means 111, 112 of the respective ends of the sheets are developed together parallel.

In this way, it is possible to retain and transport the respective sheet A, in a simplified way, with a structure of supporting and conveying means that is substantially independent of the size and shape of the rough-shaped sheet.

Practically, as it will become more clear by the following of the present description, it will be possible to make quick and easy adjustments of the device, particularly a mere adaptation of the carriageway, allowing the device to bring rough-shaped sheets with significantly different shapes and sizes between them.

As a whole, advantages are brought to the flexibility of the use of the present device compared to devices according to the art so far known.

Additionally, this method facilitates the execution of any operations upon the same sheets, in particular, as will be further illustrated, the pre-bending of the sheet in order to yield, or weaken, the resistance to bending of the sheet material will be provided, thus helping the following phases of making the container.

Preferably, said supporting and conveying means 11 advance said rough-shaped sheets with their own greater extension, or size, which is oriented transversely to the direction of advancement, according to a prevailingly linear or longitudinal path “L”, and that prevailingly develops according to a horizontal plane.

It must however be understood that said supporting and conveying means 11 may also be configured to advance said rough-shaped sheets with their own greater extension, or size, longitudinally oriented, i.e. oriented in the advancement direction “L”.

Other arrangements of the conveyed rough-shaped sheets are however conceivable.

In addition, in the present device the rough-shaped sheet is conveyed according to a predominantly linear or longitudinal path, which prevailingly develops according to a horizontal plane.

The present supporting and conveying means advance sheets A, which are in the form of an article, essentially two-dimensional, or flat, retaining them in a respective plane advancement.

Said means 11 for supporting and conveying sheets comprise means 121, 122 for supporting and conveying respective sheet retaining means 111, 112 between the upstream receiving end 11A of the same sheets A and the downstream unloading end 11B of the same sheets.

As is well apparent from FIG. 2, advantageously, said means 111, 112 for retaining respective ends A1, A2 of sheet A are transversely spaced from each other, defining a corresponding free space between them.

Moreover, advantageously, also the said means 121, 122 for conveying the retaining means 111, 112 are transversely spaced from each other, defining a corresponding free space between them.

Advantageously, said retaining means of the respective sheet are in the form of grasping means 111, 112 of a respective end, or part, of sheet A1, A2, said grasping means firmly holding said sheet engaging upper and lower opposite sides of the respective portion of sheet.

In more detail, said grasping or tightening means comprise for each sheet A, respective first and second pliers 111, 112 for grasping opposite transversal ends A1, A2 of the advancing sheet.

As shown, a plurality of holding or grasping pliers, 111, 112, are provided for each side of the device, said pliers 111, 112 being fixed in positions equally spaced longitudinally and transversely corresponding to each other, to respective supporting and conveying means 121, 122. As shown, to the pliers 111, provided in correspondence to respective first conveying or dragging means 121, correspond respective opposite pliers 112, provided on the second conveying or dragging means 122, traveling parallel to, and transversely spaced from, the first dragging means 121.

As is well apparent, referring to FIGS. 5 and 6, whereas only the pliers 112 in correspondence with the conveying means 122 are shown, each of the pliers 111, 112 present respective and opposite jaws 113a, 113b engaged with opposite faces of the rough-shaped sheet, said jaws tightening and retaining a corresponding portion of the sheet A.

The respective gripping jaw includes, therefore, a fixed jaw 113a, on which lays the respective end, or portion, of sheet A and a moving jaw 113b movable to and from said fixed jaw.

Said first and second jaw 113a, 113b are normally pushed towards and against one another. In particular, the moving jaw 113b is maintained, normally, pushed towards and against said fixed jaw 113a.

Particularly, the fixed jaws 113a define a support plane of the sheets, while the moving jaws 113b define the retaining means of sheet A on the support plane defined by the same fixed jaw 113a.

The conveying means 121, 122 are together extended parallel, advancing from upstream to downstream, driven, as shown in FIG. 3A, between respective longitudinal guides 117a, 117b, in the form of respective grooves obtained in opposing side rims 117′, 117″ of the respective conveyor 121, 122. Said rims 117′, 117″ are extended parallel in the advancement direction and are transversely spaced between them.

According to another point of view, the present retaining means 111, 112 comprise a corresponding block 114, defining supporting means for the respective sheet A, i.e. a respective extreme portion A1, A2 of the respective sheet A.

In particular, block 114, of the respective retaining means 111, 112, is fixed by screws 115, to the corresponding conveying and dragging means 121, 122.

Said block 114 presents one end, or portion, 114a, of fastening to conveying means 121, 122 and one end or portion, 114b, protruding from it, with respect to the corresponding inner edge of the conveying and dragging means 121, 122.

Practically, the protruding portion 114b extends toward the central or the midway part of the device, i.e. toward the other of said retaining means 111, 112.

Advantageously, the protruding portion 114b presents a corresponding free end, which is adapted to define said fixed jaw 113a of said grasping means.

In the prevailing horizontal conveyor span of the rough-shaped sheet A, the fixed jaw 113a is disposed below the moving jaw 113b.

In this horizontal span, the protruding portion 114b is adapted to extend below the sheet A.

Particularly, said block 114 is defined by, or comprises, a corresponding elongated small plate 118, particularly of a metallic material, which presents a generally quadrangular conformation in plan, in particular a rectangular shape, said small plate 118 being fixed to a corresponding lower block, or thickness, 116 by corresponding screws 117.

Said block, or thickness, 116 is, in turn, fixed by the mentioned bolts 115, to the corresponding belt, defining the conveying and dragging means 121, 122.

The elongated small plate, individually marked with the reference number 118, presents, on the projecting end 114a a corresponding internal opening, or perpendicular through hole, which is delimited by a generally quadrangular corresponding inner edge 118a.

At said opening 118a, extends a corresponding portion 118b, lowly or perpendicularly protruding from the plane of said small plate 118, said protruding portion 118b being obtained by a corresponding cut from the body of the same small plate 114 and subsequent bending with respect to a respective edge 118d, through which the oblique plate 118b remains bound to the main body of the small plate 118.

Practically, the protruding end 114a of the small plate comprises a portion, or front strip, 118c, which extends longitudinally to the advancement direction, which is connected through corresponding arms 118′c, 118″c, transverse to the advancement direction, to the portion 114a fixing to the respecting conveying or dragging means 121, 122.

From said end portion 118c of the small plate, or jaw, 114b extends toward the fastening part 114a of the small plate, the oblique portion 118b which, as shown, is slanted according to a respective angle in respect to the plane of same small plate 118.

Practically, said opening 118a is made by cutting a corresponding portion 118b, which is cut along three respective sides 118a and remains bound to the front part 118c of the small plate, through the bending line 118d.

Said cut portion 118b, after being defined, by cutting, is then bended with respect to the same small plate defining a corresponding anchor portion for a respective spring defining the moving jaw 113b, as will be better illustrated in the following present description.

As illustrated, the moving jaw 113b is, advantageously, supported on the fixed jaw 113a being anchored to said slanted portion 118b protruding perpendicularly.

The moving jaw 113b is defined by a corresponding flexible blade, which under normal retaining conditions, extend coplanar and parallel, but also contacting the corresponding fixed jaw 113a.

The present device therefore presents a corresponding metal blade 119, which has a first span, or portion, 119a, defining the moving jaw 113b, and a span or portion 119b, defining the means for anchoring to the fixed jaw, i.e. to the slanted plane 118b of the same, but also an intermediate span or portion 119c that acts as a link between said portion defining the moving jaw 119a and the anchor portion 119b.

The portion 119b of the blade 119 is fastened, by way of a corresponding screw and self tightening nut 120, passing through corresponding holes of said slanted plane 118b and of the same anchor portion 119B.

There are also provided elastic pushing means of said moving jaw 113b against the respective fixed jaw 113a.

Rightly so, the flexible blade 119 defines elastic means adapted to normally retain said moving jaw 113b against said fixed jaw.

As illustrated, the blade 119 is conformed, when viewed from the side, in a generally triangular shape, with the anchor portion 119b, which converges towards the active portion of greater length 119a, which defines the moving jaw 113b.

To ensure proper elastic deformation, said connecting portion 119c is characterized by a first span 119′c and by a second span 119″c, defining between them a respective angle, that bend said portion 119c protruding within the triangular configuration of the blade 119.

There are also provided actuating means of the grasping jaws under a mutual disengagement action, or separation.

Said actuating means disengage the moving jaws 113b from the fixed jaws 113a and are provided at the upstream end, in 13′, and the downstream end, in 13″, of the device and are in the form of small hinged arms 13, operating between a raised, or spaced position of the respective engaged element and a lower or engaged position, in which said pliers operate disengaged, i.e. the moving jaw 113b from the respective sheet A, said moving jaw moving away from fixed jaw 113a, as illustrated in FIG. 3A.

The active end of the small hinged arm 13 presents a corresponding engagement wheel 13a.

In particular, the arms or levers, 13, operating in 13′, rotate according to a longitudinal or horizontal axis, while the arms or levers 13, operating in 13″, rotate according to a respective perpendicular, or vertical axis.

The retaining means 111, 112 comprise respective means operable in a disengaging action of said retaining means from the respective sheet A. Said operable means of disengagement of the respective sheet comprise an arm 119e, able to be engaged by said actionable lever 13, said small arm 119e being united with the movable jaw 113b and protruding perpendicularly from it.

Said arm 119e presents a portion 119f which is united with the corresponding movable blade 113b, to which is conveniently welded or otherwise united, and from which the engaged portion 119e extends defining a corresponding obtuse angle within it.

Said small arm 119e operable in a disengaging action from the relative sheet A presents a general conformation and is made from a respective small plate having a span 119f united at the upper part to the jaw blade 119, or at the longest span 119a of the blade 119, and a second span 119g, extending towards the respective conveying means 121, 122, i.e. toward the outer sides of the device. The said advancement means 121, 122 of the retaining means 111, 112 of the sheets, or conveying means, are in the form of respective flexible elements, defining a respective endless path, particularly defined by corresponding toothed belts carried on respective extreme longitudinal pulleys 121a, 121b, 122a, 122b.

Furthermore, said conveying means present relative support elements 121C, 122C, better illustrated in FIG. 3.

Said retaining means 111, 112 are transversely movable according to the corresponding size, or length of the sheets A to be grasped and moved.

In this way, it is possible to adjust the width, or pathway, of the device to the length of the sheet to perform appropriate and easy size change adjustments.

As shown, means 121c, 122c for supporting the retaining means 111, 112, are provided, which are movable on respective guides 101, 102, which extend transversally being supported by the fixed support means 10 of the device.

Said guides 101, 102 are in the form of respective cross shafts able to be inserted with the interposition of respective sliding bushings 103 inserted into corresponding holes formed in said frames 121c, 122c.

The bushings 103 present respective enlarged heads that define engaging members against end-stops 101′, 101″, 102′, 102″, fastened to the ends of guides 101, 102.

Also provided are means 121d, 122d for actuating the transverse movement of said retaining means 111, 112, between the fixed support means 10 and the support means 121C, 122C of the retaining means.

Said means for actuating the transverse movement of said retaining means 111, 112 are in form of corresponding operating screws 121d, 122d provided between the fixed support means 10 and the respective support member 121C, 122C.

Also advantageously provided are means for processing the sheet, which are preferably in the form of means of pre-bending of said sheet A. Particularly, said processing or pre-bending means, are provided in an intermediate position of the sheet conveying path and are identified by the reference number 41.

Said pre-bending means 41 of the sheet comprise a member for engaging and bending a corresponding panel of the sheet, particularly a member, or pusher, for engaging and bending a first and second longitudinally opposing panels A0, A0 of sheet A.

Said pusher, or member, 41, of engagement and bending, is perpendicularly movable to the prevalent extension and advancement plane of the rough-shaped sheets, and extends between said retaining means 111, 112.

Practically, the said means for processing the sheet A are extended between retaining means 111, 112, which retain the opposite ends A1, A2 of the rough-shaped sheet A.

Said pre-bending means of the sheet further comprise means of contrast of said engaging and bending means, said means of contrast being labeled with the reference number 51, in FIG. 1.

Practically, said member or pusher, 41, of engagement and bending is perpendicularly movable between an advanced bending position and a rear position, in which lies below, or outside, of the path, or trajectory, of said sheets, positioning itself in a position of free advancement of said sheets A.

Said engaging and bending position is an upper position of the said bending member 41, while the rear position of free advancement of the sheet is a lower position.

Said engaging member 41 comprises, or has the form of, a shaped vane having a flat portion of support for the central part of the rough-shaped sheet, marked with the reference number 41a, and a corresponding lateral portion, in particular a first and a second opposite lateral portions 41b, 41c, perpendicularly protruding from said flat central portion 41a, slanted at an angle to same portion.

As illustrated, said vane 41 has a flat portion that is the same size of the central panels of the rough-shaped sheet, so that the same slanted protruding portions 41b, 41c extend correspondingly to the point of interference with the respective longitudinal bending lines A, “A” of the rough shaped sheet.

It is obtained by the effect of contrast with the plunger, or with the full body 51, i.e. of its lower surface 51a, the bending of the rough shaped sheet, with the respective side panels, which are facing upwards, i.e. protruding perpendicularly, presenting an angle with respect to the corresponding central panel of the rough-shaped sheet, as shown in FIG. 1.

As illustrated, said contrast means 51 of said engaging and bending means are movable between an advanced or lower position of engagement and contrast of said vane 41, and a retracted or upper position for freely advancing said sheets A.

Practically, the full portion 51 defining the contrast means of the bending vane present a lower surface, or width, which corresponds to that of the upper surface of the central part 41a of the pushing member.

In this way, it is possible to achieve a pre-bending of panels that extend primarily in the direction transverse to the advancement direction, i.e. a bending of the panels of the rough shaped sheet with respect to lines that are transverse to the longitudinal advancement direction of the rough-shaped sheet.

Said bending pusher 41 and said contrasting block 51 are moving in unison, one against the other, for bending the corresponding panels of the rough-shaped sheet.

According to the finding, the processing means comprise, also, conducting the bending of at least one corresponding panel, or flap, AE according to a longitudinal line of bending A′, i.e. according to a line parallel to the longitudinal advancement direction.

Particularly, said pre-bending means of the extreme panel AE of the rough-shaped sheet A are defined by grasping means, or pliers, 112, that provide said bending at the collecting, or receiving moment, of a corresponding sheet A.

Practically, the extreme panel AE of the rough-shaped sheet is re-bended, or rotated, completely upon the laying panel A0 by way of the grasping of jaws of the pliers 112, at the moment of withdrawal of the rough-shaped sheet by the retaining means 112, in the position marked with the reference 13′.

The moving jaw 113b engages from behind the extreme panel AE of the rough-shaped sheet and re-bends it, or rotates it, substantially at 90°, to push it into contact with the opposite upper face of the adjacent panel A0.

Advantageously provided are also means 61 for withdrawing the sheets from a corresponding magazine 21 and for delivering said sheets A to the supporting and conveying means 11.

Said means of withdrawing and delivering comprise, therefore, a corresponding arm 61 movable between a withdrawing position and a delivering position, in which the respective sheet A extends according to the prevailing resting and advancement plane of the rough-shaped sheets A.

To grasp, from the respective magazine 21, a corresponding sheet, said withdrawing and delivering means 61 comprise means for engaging and retaining the sheets, which are, in particular defined by corresponding suction bellows, bearing the reference number 61a in the attached figures.

Said engagement and retaining means 61a engage a central area of the respective rough-shaped sheet, in particular a lower face of the same sheet A.

Said withdrawing and delivering means 61 of the rough-shaped sheets extend, in condition or position of delivery, between corresponding retaining means 111, 112.

As shown, the sheet-housing magazine 21 is in the form of a tubular body having one sheet loading end 21″ and one sheet emission end 21, at correspondence of which extend said collecting and delivering means at the withdrawing position of a corresponding sheet.

As illustrated, said tubular magazine 21 presents a generally quadrangular shape, particularly rectangular, and is defined by opposing walls respectively marked with reference numbers 21a, 21b, 21c, 21d.

Advantageously, as shown, the width, or distance between the side walls 21c, 21d of the device is less than the length of the respective sheet A, in order to keep, within the tubular body of the magazine 21, the same sheet with an extreme panel AE in a perpendicularly re-bent condition to the main part of the rough-shaped sheet.

In this way, it is possible to prepare the next pre-bending operation of same extreme panel AE, by way of said grasping or still-retaining means 112.

Practically, being withdrawn by said withdrawing means 61, already with the flap AE facing perpendicular to the rough-shaped sheet, only when the rough-shaped sheet is delivered to the grasping means, the respective pliers 112 engage against an outer surface of said panel AE and bends it with the opposite face in contact with the adjacent panel A0 of the rough-shaped sheet.

The arm 61b, which carries the suction cups 61°, moves in a rotation-translation motion between the withdrawing position and the release position, remaining between the retaining means 111, 112 and the respective conveying means 121, 122.

The retaining suction cups 61a are placed between the retaining means 111, 112 and the respective conveying means 121, 122 in a releasing condition of sheet A.

In particular, the arm 61b that carries the suction cups 61a moves in a rotation-translation motion, providing a rotational motion with respect to a transverse axis and is simultaneously lowered, in order to allow advancement of the engaging end 61a of the respective sheet A, between the slanted exit mouth from the magazine and the horizontal or coplanar sheet delivery position to the conveying plane, keeping said sheet substantially at the same height level.

Also provided are transfer means 71 of sheets from the supporting and advancement means 11 to forming means 31 of a corresponding container or container part.

Said transfer means comprise a respective ejector 71, which is movable between a retracted position, for freely advancing the supporting and advancement means 11, i.e. freely advancing sheets A, and an advanced, intermediate position, for engaging the respective sheet A in the unloading position, and an advanced end position for delivering the sheet A to the forming means 31, i.e. for inserting the sheets A on a respective seat 31a of said forming means.

Said transfer means 71 define means for unloading the sheet from the supporting and advancing means 11 and extend, and move, according to a longitudinal direction, i.e. parallel to the prevalent advancement path or travelling direction of the rough-shaped sheets.

As illustrated, said unloading, or transfer means of the respective sheet, engage a respective sheet that is placed perpendicular to the prevalent resting and advancement plane of said rough-shaped sheets, in order to push it with radial motion with respect to the wheel 31, against a seat 31a, frontally placed, of forming means 31, which are defined by a corresponding wheel rotating around an axis transverse to the prevailing longitudinal direction of advancement of said sheets A.

Particularly, the shaping wheel 31 is oriented with the respective axis parallel to the rotation axis of the extreme pulleys 121a, 121b, 122a, 122b of conduction of means 121, 122 for conveying pliers holding said rough-shaped sheets.

As illustrated, said unloading, or transfer means, 71 comprise respective means for engagement and retention of rough-shaped sheets, which are, in particular, defined by the respective suction cups 71a, which engage a central area of the respective sheet A.

As illustrated, advantageously said means 71 for unloading the sheets extend between corresponding lateral retaining means 111, 112 of the rough-shaped sheets.

Said transfer means 71 move perpendicularly to sheet A, when in releasing or unloading position and remain positioned between the retaining means 111, 112 and the respective conveying means 121, 122.

The present supporting and advancement means advance, or feed, rough-shaped sheets with alternate advancement motion in which the advancement motion phases are longer than stop phases, and during the latter are provided pre-bending, or processing operations in an intermediate zone of the device along with the loading of a new rough-shaped sheet A upon supporting and advancement means 11 and the unloading of a corresponding rough-shaped sheet A from the support and advancement means 11.

The finding thus conceived is susceptible to evident industrial application; it can be also subject to numerous modifications and variants which pertain to the scope of the invention; all details can also further be substituted by technically equivalent elements.

1.-50. (canceled)

51. A device (1) for supplying sheets (A) made of bendable material for making a corresponding container, or part of a container, said container defining a package for housing respective elongated elements composed of cigarettes, the device comprising:
means (11) for supporting and conveying the sheets (A) along a respective path, said supporting and conveying means (11) comprising first and second means (111, 112) that retain respective ends (A1, A2) of each sheet (A), said retaining means (111, 112) being grasping means of a respective end (A1, A2) of each sheet (A), which firmly keep said sheet by engaging opposite faces of the sheet, said grasping means comprising corresponding pliers having respective jaws (113a, 113b) for engaging and tightening opposite faces of a related sheet (A), said jaws (113a, 113b) comprising a fixed jaw (113a), on which the sheet (A) rests, and a moving jaw (113b) moving from and toward said fixed jaw (113a), wherein the moving jaw (113b) is defined by a corresponding flexible blade (119), said blade (119) preferably having an anchoring portion (119b).

52. The device according to claim 51, wherein said supporting and conveying means (11) comprise means (121, 122) for conveying the retaining means (111, 112) between a receiving end (11A) of said sheet (A) and an unloading end (11B) of the same sheet (A).

53. The device according to claim 51, wherein said means (111, 112) for retaining the respective ends (A1, A2) of the sheet (A) are transversally spaced, defining a free space between them.

54. The device according to claim 51, wherein said grasping means comprise, for each sheet (A), respective first and second grasping pliers (111, 112) for opposite ends (A1, A2) of the sheet.

55. The device according to claim 54, wherein a plurality of grasping pliers (111, 112) are fixed on corresponding conveying means (121, 122).

56. The device according to claim 51, wherein said retaining means (111, 112) comprise a corresponding block (114), which has an end (114b) projecting with respect to a corresponding edge of conveying or dragging means (121, 122) defining the fixed jaw (113a) of corresponding grasping means, said block (114) comprising a corresponding elongated small plate (118) having a front portion (118c) from which the block (114) extends and defining a respective angle, a slanted portion (118d) defining anchoring and supporting means for the moving jaw (113b).

57. The device according to claim 51, wherein the moving jaw (113b) is supported by the fixed jaw (113a) and said blade (119) has a connecting portion (119c) defining elastic retaining means of the moving jaw onto the fixed jaw.

58. The device according to claim 51, wherein the retaining means (111, 112) comprise means (119e) actuated under a disengagement action of the respective sheet.

59. The device according to claim 51, wherein means (121c, 122c) for supporting the retaining means (111, 112) are configured to be transversally moved depending on a corresponding size of the sheets, said means (121c, 122c) being moved on respective transverse guides (101, 102), which extend from fixed supporting means (10) of the device, wherein means (121d, 122d) are provided for actuating a transverse movement of the retaining means (111, 112), which are provided between the fixed supporting means (10) and the means (121c, 122c) for supporting the retaining means.

60. The device according to claim 51, further comprising means (41) for treating the sheet made as means for pre-bending the sheet configured to bend a corresponding panel along a line parallel to a sheet advancement direction, said means (41) for treating the sheet being provided in an intermediate position of the sheet conveying path and extending between the retaining means (111, 112) of the sheet.

61. The device according to claim 60, wherein said pre-bending means bend a corresponding panel along a transverse line to the sheet advancement direction.

62. The device according to claim 60, wherein said means (41) for prebending the sheet comprise an engaging and bending member of a corresponding sheet panel, or comprise an engaging and bending member (41) of a first and a second sheet panel.

63. The device according to claim 62, wherein said engaging and bending member (41) are configured for moving perpendicularly to a resting and advancement plane of sheets, between an advancement engaging and bending position and a retracted position for freely advancing the sheets.

64. The device according to claim 62, wherein said engaging and bending member (41) comprises a shaped vane having a plane portion (41a) and a corresponding perpendicularly projecting side portion (41b, 41c) for bending a corresponding sheet panel.

65. The device according to claim 62, wherein said means for pre-bending the sheet comprise abutment means (51), made as a corresponding filled portion (51), for said engaging and bending means, moving perpendicularly to the sheet advancement plane, and in particular moving between an advanced engaging and abutting position and a retracted position for freely advancing the sheets.

66. The device according to claim 60, wherein said pre-bending means are defined by corresponding retaining means (112), which perform said pre-bending upon withdrawing a corresponding sheet (A).

67. The device according to claim 51, wherein means (61) are provided for withdrawing the sheets from a magazine (21) and for delivering said sheets to supporting and conveying means (11) and means (71) are provided for unloading the sheets from the supporting and conveying means (11).
